(19) United States
(12) Patent Application Publication
(10) Pub. No.: US 2026/0079294 A1
(43) Pub. Date: Mar. 19, 2026

(54) AUTOMATED SILICON PHOTONICS BONDING INTERFACE ENHANCEMENT

(71) Applicant: OpenLight Photonics, Inc., Goleta, CA (US)

(72) Inventors: Jaehyuk Shin, Goleta, CA (US); Mark Williams, Reno, NV (US)

(21) Appl. No.: 18/887,361

(22) Filed: Sep. 17, 2024

(51) Int. Cl. G02B 6/122; G02B 6/12; G02B 6/13; G02B 6/136

(52) U.S. Cl. CPC G02B 6/1228; G02B 6/12004; G02B 6/131; G02B 2006/12114; G02B 6/136

(57) ABSTRACT

A silicon photonic device includes a substrate formed from a silicon-containing material and patterned to comprise a first waveguide and a second waveguide defining a first trench extending between the first waveguide and the second waveguide. The first waveguide and second waveguide have upper surfaces exposed for bonding to an epitaxially grown layer. The first trench being exposed to the epitaxially grown layer. A support structure is formed within the first trench and extends upward to an upper surface at a height of the upper surfaces of the first waveguide and second waveguide. The support structure is optically non-functional.

### TECHNICAL FIELD

The present disclosures relate to silicon photonics technology and, in some examples, to methods and systems to automatically insert support structures in trenches between waveguides for improving bond yield in photonic integrated circuits.

### BACKGROUND

Silicon photonic devices integrate optical components and electronic circuits on silicon substrates. This technology leverages semiconductor manufacturing processes to create photonic integrated circuits (PICs) that can manipulate light at the micro- and nano-scale.

In the design and manufacturing of PICs, there is a need for automated processes to handle the complexity and scale of modern photonic circuits. Electronic design automation (EDA) tools play a role in optimizing layout features for these intricate designs.

### BRIEF DESCRIPTION OF THE SEVERAL VIEWS OF THE DRAWINGS

The following description includes discussion of figures having illustrations given by way of example of implementations of embodiments of the disclosure. The drawings should be understood by way of example, and not by way of limitation. As used herein, references to one or more “examples” or “embodiments” are to be understood as describing a particular feature, structure, or characteristic included in at least one implementation of the inventive subject matter, in at least some circumstances. Thus, phrases such as “in one example”, “in some examples”, “in some embodiments”, “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number may refer to the figure (“FIG. ”) number in which that element or act is first introduced.

FIG. 1 is a perspective view illustrating a support structure for a silicon photonic device, according to some examples.

FIG. 2 is a series of cross-sectional views illustrating the process of bonding epitaxial layers to silicon waveguides without a support structure, according to some examples.

FIG. 3 is two cross-sectional views illustrating the process of bonding epitaxial layers to silicon waveguides with a support structure, according to some examples.

FIG. 4 is a top view illustrating the placement of a support structure between converging waveguides in a silicon photonic device, according to some examples.

FIG. 5 is a top view illustrating the placement of a support structure between merging waveguides, showing a merge location and a merge distance used to place the support structure, according to some examples.

FIG. 6 is a top view illustrating the placement of a support structure between converging waveguides, showing the angle of placement, according to some examples.

FIG. 7 is a top view illustrating a support structure placement in a silicon photonic device using a first example of determining a first end of the support structure, according to some examples.

FIG. 8 is a top view illustrating a support structure placement in a silicon photonic device using a second example of determining a first end of the support structure, according to some examples.

FIG. 9 is a flowchart illustrating a method for automatically inserting support structures in a silicon photonic device layout, according to some examples.

Descriptions of certain details and implementations follow, including a description of the figures, which may depict some or all of the embodiments described below, as well as discussing other potential embodiments or implementations of the inventive concepts presented herein. An overview of example embodiments of the disclosure is provided below, followed by a more detailed description with reference to the drawings.

### DETAILED DESCRIPTION

In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, structures, and techniques are not necessarily shown in detail.

The yield of silicon photonic devices is influenced by various factors, including the quality of material interfaces and the robustness of bonded layers throughout the manufacturing process. Addressing yield challenges is an ongoing focus in the development of silicon photonics technology.

One of the challenges in silicon photonics is the integration of different materials to enhance functionality. An example of such a challenge is the bonding of compound semiconductor materials to silicon structures, which is a complex process that requires precise control over material interfaces. When the bonding process fails or gives rise to defects during other manufacturing steps, the resulting device may not be viable, thereby decreasing yield.

The yield of viable units (e.g., PIC devices) from the bonding process is referred to herein as bond yield.

The fabrication of silicon photonic devices often involves etching trenches around waveguides to guide light effectively. However, these etched features can create topological variations that affect the structural integrity of the device layers, and thereby decrease bond yield.

The described examples address challenges in the fabrication and design of photonic integrated circuits (PICs), particularly focusing on improving bond yield and automating the insertion of support structures to improve the robustness and reliability of the bonding process.

In silicon photonics, waveguides are fundamental components used to guide light. To create a waveguide, trenches are etched on both sides of a silicon rib structure. These trenches serve to confine light within the waveguide. However, in hybrid silicon photonics applications, where compound semiconductor materials are bonded on top of silicon waveguides, challenges arise in the robustness of the bond above wide trenches.

In particular, locations in the device layout where two waveguides merge present challenges for bond yield. When two waveguides converge, their adjacent trenches overlap, creating a wider trench area. This wider trench can span up to twice the width of a single trench.

The absence of supporting silicon in this expanded trench region leads to a weak bonding site for the compound semiconductor material above. This weakness can result in reduced bond yield and potential device failures. In addition, the point at which two waveguides merge or converge can result in a sharply pointed end of a third waveguide between the two merging or converging waveguides; these sharp points can give rise to problems during bonding.

To address this issue, the described examples introduce a method for automatically inserting support features in these problematic areas during the automated circuit design process. For example, EDA software used to automate aspects of the device layout can include functionality to identify areas of the circuit layout in need of support, such as wide trenches, and automatically determine the location, orientation, and length of support structures to insert into these areas.

These support structures are designed to provide additional bonding surface without affecting the optical performance of the waveguides. In some examples, the support structures are elongate rectangular prisms with ends rounded in the horizontal plane, approximately 0.5 microns in width. In some examples, the support structures are inserted when the unsupported trench width exceeds 4 microns. The rounded ends of the supports can reduce the risk of breakage of the epitaxial layers grown on top of the structures. The supports can extend from existing silicon features, providing continuity in the bonding surface.

Automation of the support structure addition process can be a feature of EDA software. This software analyzes the device layout, identifies areas requiring support, and automatically inserts the support structures with the necessary orientation, length, and location. This automation ensures consistency across large and complex designs, reducing the potential for human error in the design process. Given the complexity of modern PIC designs, which can involve hundreds or thousands of waveguide merge sites per mask set, manual insertion of support structures can be impractical. Therefore, examples described herein include computer-executable methods to automatically identify areas requiring support and insert the appropriate structures.

In some examples, the automated method begins by processing a silicon substrate layout and mathematically calculating each location in the layout where two waveguides merge. Once this merge point is identified, the algorithm determines the optimal angle for the support structure. This angle can enable the support structure to provide maximum benefit without interfering with the optical properties of the waveguides.

Next, the method calculates how far a second end of the support structure should extend into the merged area. This calculation can be performed orthogonally to the previously determined optimal angle. The method also determines how far a first end of the support structure should extend out of the merge area to avoid interference with the overall design. In some examples, the location of the first end and the second end are determined first, thereby dictating the location and angle of the support structure.

Finally, the support structure is placed within a modified version of the layout. The first end and second end of the support structure are rounded, and are placed consistently with the calculated position and angle. Automating this placement can improve consistency in the application of these support features across the entire silicon photonic device design.

In some examples, the second end of the support structure is placed at a point where the width of the trench between the two converging waveguides is equal to a width threshold, such as a value between 3 microns and 5 microns, such as 4 microns.

The described examples include two alternative techniques for determining placement of the first end of the support structure. In both examples, the first end is placed to merge the support structure with a third waveguide located between the two converging waveguides. In a first example, the first end is placed at a point where a distance from the third waveguide to one of the two converging waveguides rises above a threshold. This can result in the support structure being closer to one of the two converging waveguides than the other, potentially causing reflections or higher risk of interacting with the optical mode. In a second example, the first end is placed more centrally relative to the third waveguide, such as where the width of the third waveguide equals the width of the support structure, thereby potentially reducing the risk of optical interference.

After the silicon substrate layout has been modified by the addition of the support structures, the support structures are integrated with other structures patterned into the silicon substrate during the waveguide fabrication process. Thus, the addition of the support structures does not require additional manufacturing steps, as the support structures are simply areas of silicon that are not removed during the etching of the trenches. This integration approach ensures that the supports are seamlessly incorporated into the device structure.

In some examples, the benefits of these support structures extend beyond improving the strength of the initial bonding process. The support structures can provide support during subsequent processing steps, such as the removal of the epitaxial growth substrate and upper portions of the bonded epitaxial layers. Without the support structures, the thin remaining layers of bonded material can be prone to breakage, particularly in areas having wide trenches.

The support structures can be designed and placed to minimize or reduce their effect the optical properties of the device, rendering the support structures optically non-functional.

The material, shape, and placement of the support structures can be selected to minimize any potential impact on the optical mode propagating through the waveguides. This feature can assist in maintaining the intended functionality of the photonic circuit.

During manufacturing, the support structures can contribute to improved yield by enhancing the structural integrity of the bonded interface. The support structures can provide additional bonding surface in areas that would otherwise be unsupported, reducing the likelihood of defects forming during wafer processing.

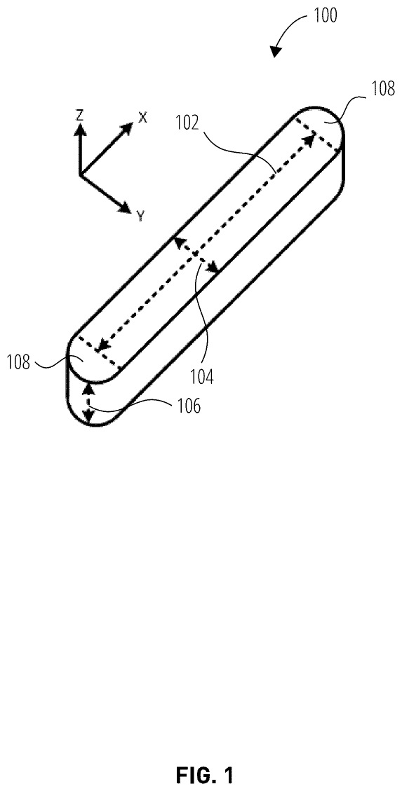

FIG. 1 is a perspective view illustrating a support structure 100 for a silicon photonic device. The support structure 100 is designed to provide additional bonding surface for a patterned silicon substrate to bond with epitaxially grown layers.

Structures described herein refer to horizontal and vertical dimensions, directions, planes, and so on. In the context of this disclosure, horizontal refers to planes defined by the X and Y axes shown in the figures, and vertical refers to the Z axis shown in the figures. Whereas the devices described herein are described with reference to the positive Z axis denoting an upward direction and the X and Y axes denoting horizontal directions, it will be appreciated that the fabrication and/or use of devices described herein can be performed with any suitable orientation of the device. The X, Y, and Z axes used herein, and any references to directions such as up, down, left, right, and so on are intended only to provide a consistent frame of reference for the relationships between the components described herein.

The support structure 100 has two rounded ends 108, rounded in the horizontal (XY) plane but extending straight up along the vertical Z axis. The rounded ends 108 help prevent breakage of the epitaxial layers grown on top of the support structure. In some examples, the support structure 100 is shaped as a rectangular prism extending horizontally between the rounded ends.

In the illustrated example, the support structure 100 has a length 102 of the rectangular prism portion, which generally extends along the direction in which the neighboring waveguides merge or converge. The width 104 of the support structure 100 can be a suitable width for supporting the bonding process, such as a width around 0.5 microns, although the width 104 may range between 0.3 microns and 0.7 microns in some examples. The height 106 of the support structure extends upward to match the height of the upper surfaces of adjacent waveguides, allowing for bonding to an epitaxially grown layer.

The support structure 100 is formed within a trench between two waveguides and is designed to be optically non-functional.

As described above, the support structure 100 provides structural support and improves bond yield in areas where waveguides merge or converge and/or where trenches overlap. The support structure 100 helps maintain the integrity of the bonded interface between the silicon substrate and the epitaxially grown layers, particularly in regions where the trench width exceeds a predetermined width threshold, such as a value between 3 microns and 5 microns, such as 4 microns.

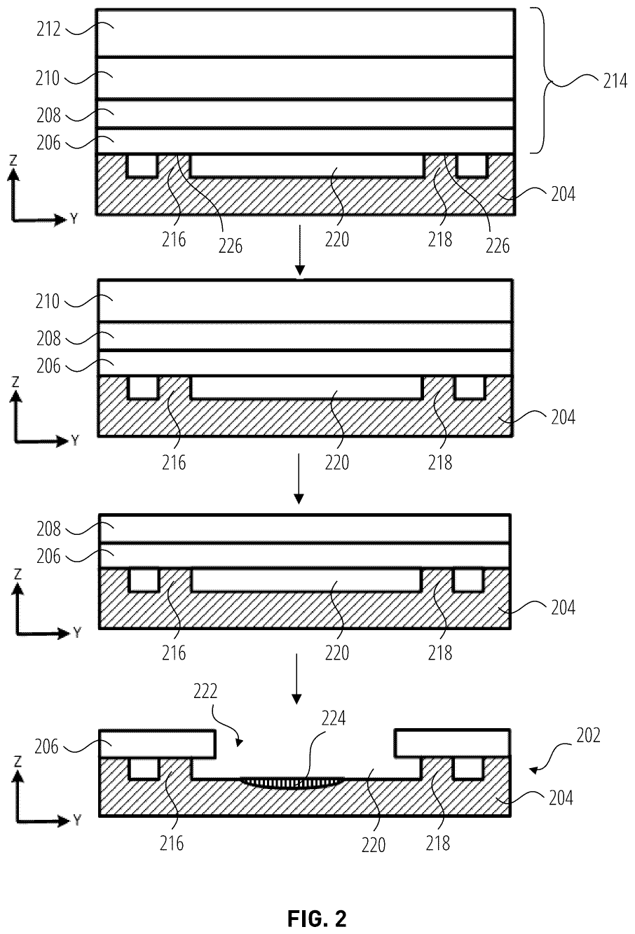

FIG. 2 is a series of cross-sectional views illustrating the process of bonding epitaxial layers to silicon waveguides without a support structure. From top to bottom, FIG. 2 shows successive stages of the bonding and epitaxial layer removal process.

At the top, an epitaxially grown structure 214 is shown bonded to a patterned top surface of a silicon substrate 204, according to a flip-chip bonding configuration. The epitaxially grown structure 214 is grown on a growth substrate 212 as a series of successively grown or deposited layers: a third epitaxially grown layer 210, a second epitaxially grown layer 208, and a first epitaxially grown layer 206, in that order. The layers of the epitaxially grown structure 214 can be semiconductor materials, such as III-V semiconductor material layers, which are commonly used in silicon photonic devices in conjunction with silicon-based waveguides.

The silicon substrate 204 is patterned to form waveguides and other optical structures. Trenches can be etched in the silicon substrate 204 to define gaps between waveguides, such as first trench 220 etched between first waveguide 216 and second waveguide 218. The silicon substrate 204 is formed from an optically suitable material, such as a silicon-containing material.

After growth of the epitaxially grown structure 214 and patterning of the silicon substrate 204, the epitaxially grown structure 214 is inverted, and its top layer (first epitaxially grown layer 206) is bonded to the top of the patterned silicon substrate 204. During bonding, the wide first trench 220 can cause problems and weaken the bond, because the only surfaces of the silicon substrate 204 available for bonding are the upper surfaces 226 of the first waveguide 216 and second waveguide 218.

After bonding, the bottom (now top) layers of the epitaxially grown structure 214 are removed. Moving down the page of FIG. 2 to the second drawing, the growth substrate 212 is removed first. Moving down again to the third drawing, the third epitaxially grown layer 210 is then removed.

The fourth and final drawing at the bottom of FIG. 2 shows what can happen during removal of the second epitaxially grown layer 208. The layer removal process can cause breakage of the first epitaxially grown layer 206 over wide, unsupported regions, such as first trench 220. If a break 222 occurs in the first epitaxially grown layer 206, the processes used to remove the epitaxial layers can damage the silicon substrate 204, shown as damage 224. The silicon photonic device 202 formed thereby may be non-functional or otherwise defective, decreasing manufacturing yield.

Accordingly, it can be beneficial to provide additional structural support in wide, unsupported regions of the silicon substrate 204.

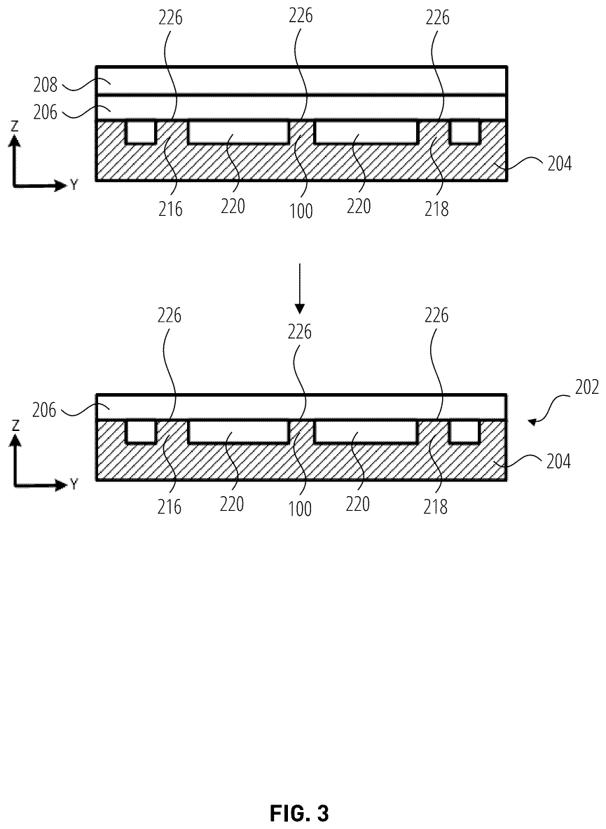

FIG. 3 is two cross-sectional views illustrating the removal of the second epitaxially grown layer 208 of an epitaxially grown structure 214 bonded to a silicon substrate 204, as in FIG. 2. In the example of FIG. 3, the silicon substrate 204 has been patterned to include a support structure 100 as shown in FIG. 1.

The support structure 100 is formed within the first trench 220, such as extending down the middle of the first trench 220. The support structure 100 is formed from the silicon substrate 204; the trench etching patterns are modified from the design shown in FIG. 2 to leave the silicon substrate 204 material in place within the first trench 220 to form the support structure 100. The support structure 100 extends upward to an upper surface 226 at the height of the upper surfaces 226 of the first waveguide 216 and second waveguide 218. The support structure 100 is designed to provide additional bonding surface in unsupported areas, such as areas where waveguides merge and trenches overlap. By providing additional support in these critical areas, the support structure 100 can help to maintain the integrity of the bonded interface throughout the fabrication process, prevent breakage of the first epitaxially grown layer 206, and/or prevent damage to the silicon substrate 204, thereby potentially improving the overall yield of the manufacturing process for the silicon photonic device 202.

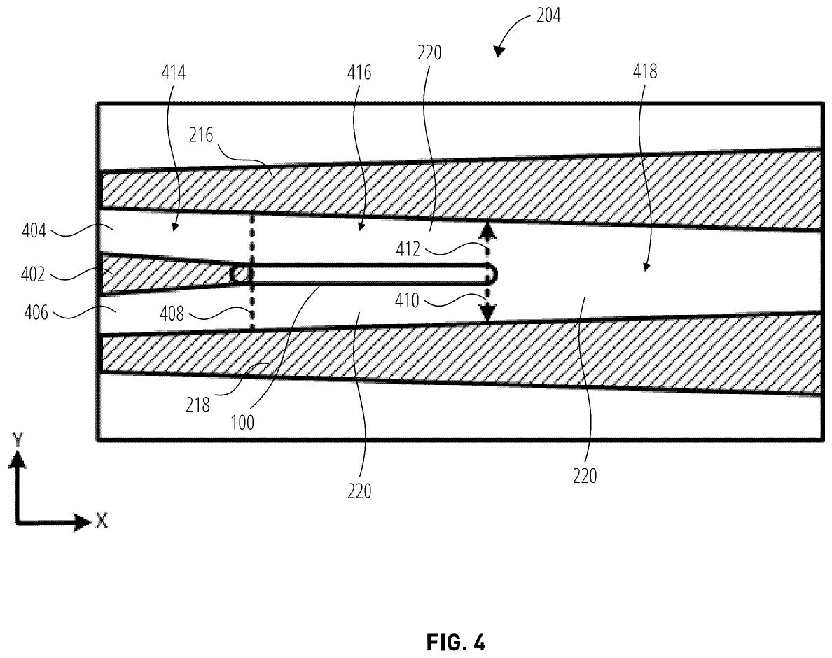

FIG. 4 is a top view of a patterned silicon substrate 204 of a silicon photonic device 202, illustrating the placement of a support structure 100 between converging waveguides in the silicon substrate layout.

The silicon substrate 204 is patterned, according to an original (unmodified) silicon substrate layout, to include a first waveguide 216, a second waveguide 218, and a third waveguide 402. These waveguides are part of the patterned silicon substrate 204 and serve to guide light within the device.

In the unmodified layout, the first trench 220 is defined between the first waveguide 216 and the second waveguide 218. Additionally, a second trench 404 is formed between the first waveguide 216 and the third waveguide 402, while a third trench 406 is located between the second waveguide 218 and the third waveguide 402.

In the illustrated example, the distance between the first waveguide 216 and the second waveguide 218 decreases in a horizontal direction, specifically along the X axis in the positive X direction. This decreasing distance creates three distinct regions: a first region 414, a second region 416, and a third region 418.

In the first region 414, to the left of boundary 408, the third waveguide 402 is located between the first waveguide 216 and the second waveguide 218. The second trench 404 and third trench 406 in this region have widths no greater than a width threshold, such as 4 microns. In some examples, the width threshold for these trenches is different from the width threshold used to determine placement of the support structure 100 as described below.

The second region 416 begins at boundary 408 where the third waveguide 402 ends. In the second region 416, the first trench 220 extends from the first waveguide 216 to the second waveguide 218 over a width greater than the width threshold, which is shown by width 412 at the right boundary 410 of the second region 416. Because the first trench 220 is wider than the width threshold in the second region 416, there is a need for additional structural support in this region.

The third region 418 is where the first trench 220 narrows to a width no greater than the width threshold. The third region 418 begins at the boundary 410 and extends to the right. Thus, the width of the first trench 220 at the boundary 410 is equal to the width threshold, namely width 412.

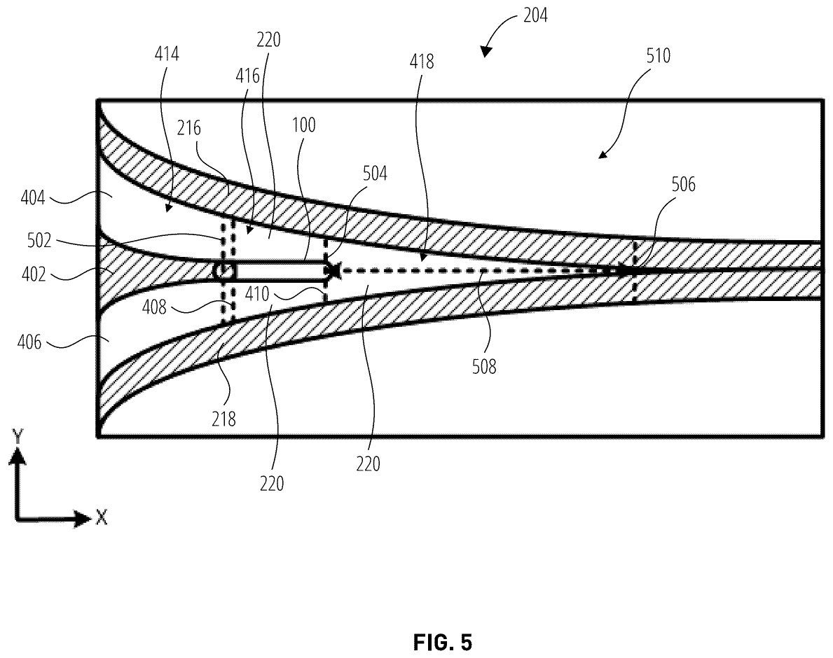

As used herein, the width of a structure (such as a trench, a waveguide, or a support structure) at a given horizontal location can be regarded as the minimum width passing through that location. Thus, for example, width 412 is the shortest distance from the first waveguide 216 to the second waveguide 218 that passes through the location at the center point of the line segment denoting the width 412. This determination is relevant to determination of the angle at which a support structure 100 should be placed, as described in greater detail below with reference to the non-linear geometries of FIG. 5 through FIG. 8.

Returning to FIG. 4, the silicon substrate layout can be modified to include a support structure 100 placed within the first trench 220 such that it extends from a first end 502 that merges with the third waveguide 402 in the first region 414 to a second end 504 that extends to a boundary 410 between the second region 416 and the third region 418. The support structure 100 thereby extends through the second region 416, providing support in that region of the first trench 220 that has a width greater than width 412. Techniques for determining the placement and size of the support structure 100 based on the silicon substrate layout are described in greater detail below.

FIG. 5 is a top view illustrating another example placement of a support structure 100 between merging waveguides. The first waveguide 216 and second waveguide 218 merge together at a merge location 506, such that the area of the silicon substrate 204 shown in FIG. 5 is referred to as a waveguide junction 510.

FIG. 5 includes structural elements similar to those of FIG. 4, such as a first waveguide 216, a second waveguide 218, a third waveguide 402, a first trench 220, a second trench 404, and a third trench 406. However, in FIG. 5, the first waveguide 216 and second waveguide 218 are curved instead of being linearly tapered as in FIG. 4. It will be appreciated that the techniques and structures described herein can be applied to silicon substrate layouts having various different waveguide shapes and orientations.

In FIG. 5, as in FIG. 4, the distance between the first waveguide 216 and the second waveguide 218 decreases in a horizontal direction, again defined as the positive X direction.

This decreasing distance creates a first region 414, a second region 416, and a third region 418, as in FIG. 4.

In this example, however, the second end 504 of the support structure 100 is placed at a specific location based at least in part on a merge distance 508 from the merge location 506. The length 102 and orientation of the support structure 100 are a function of the locations of the first end 502 and second end 504, and can be determined in some examples by the need to support wide trench regions (e.g., second region 416) as well as the need to avoid interfering with optical behavior of the waveguides by maintaining at least a threshold merge distance 508.

Thus, techniques described herein can be used to determine a location of the second end 504, as shown by the dashed line at the boundary 410 between the second region 416 and third region 418, as well as a location of the first end 502, shown by a dashed line located within the first region 414.

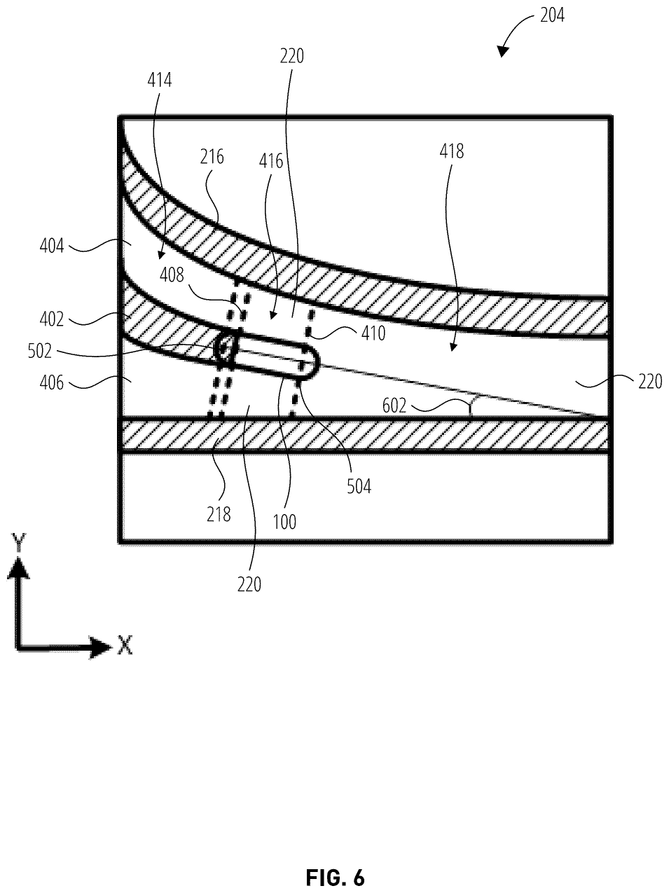

FIG. 6 is a top view illustrating another example placement of a support structure 100 between converging waveguides. FIG. 6 includes structural elements similar to those of FIG. 4 and FIG. 5, such as a first waveguide 216, a second waveguide 218, a third waveguide 402, a first trench 220, a second trench 404, and a third trench 406 defining a first region 414, a second region 416, and a third region 418.

The dashed lines showing the locations of the first end 502 and second end 504 in this example are at an angle to the Y axis instead of being parallel to the Y axis as in FIG. 5. This angle is the same as angle 602 shown as the angle between the longitudinal (length-wise) axis of the support structure 100 with the substantially straight second waveguide 218. However, it will be appreciated that in some examples the angle 602 is defined with respect to a tangent from a curved waveguide surface.

Techniques described below can be used to automatically determine the optimal angle 602 for placement of the support structure 100, as well as an optimal length 102 for the support structure 100. Alternatively, in some examples, the techniques automatically determine locations for the first end 502 and the second end 504, which in turn dictate the angle 602 and length 102.

As shown in FIG. 6, the angle 602 is such that the support structure 100 extends perpendicularly to the lines indicating the boundary 408 and boundary 410, corresponding to the minimum widths at those locations, as described above. In some examples, the lines of minimum width at the boundary 408 and boundary 410 can be used to determine the angle 602 of the support structure 100.

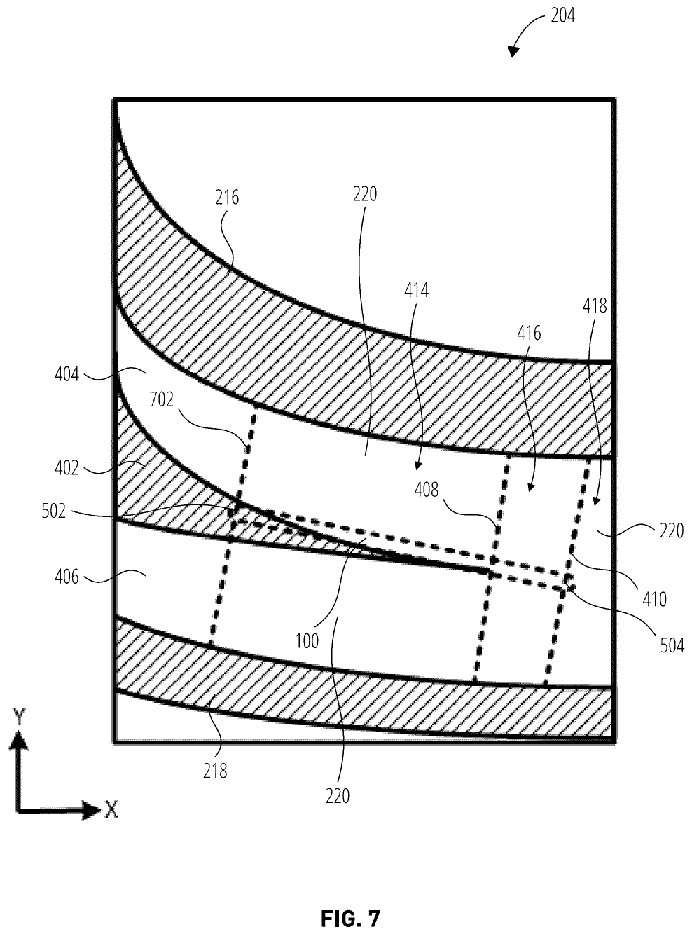

FIG. 7 is a top view illustrating a further example placement of a support structure 100 between converging waveguides, using a first example technique for determining a location for the first end 502 of the support structure 100.

In this first example technique, a first location 702 is identified. The first location 702 indicates a point along the third waveguide 402 at which the width of the second trench 404 is greater than a width threshold (which can be the same as or different from the width thresholds described above). The first end 502 is then placed at this first location, at a position overlapping the third waveguide 402 such that the support structure 100 extends smoothly from the surface of the third waveguide 402 to narrow the width of the second trench 404 without resulting in any discontinuities in the surface of the third waveguide 402.

In some examples, such as the example illustrated in FIG. 7, the second end 504 of the support structure 100 can be placed at a midpoint of the boundary 410 between the second region 416 and third region 418, equidistant from the first waveguide 216 and second waveguide 218.

The first example technique applied in FIG. 7 can give rise to unwanted optical behavior due to the greater proximity of the support structure 100 to the first waveguide 216 than the second waveguide 218, as described above.

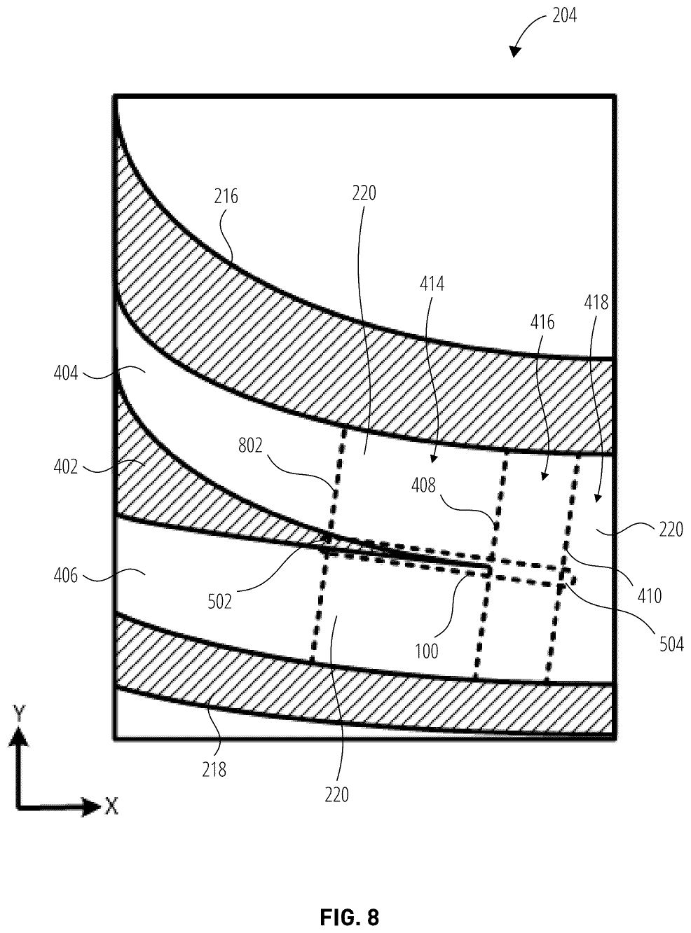

FIG. 8 is a top view illustrating a further example placement of a support structure 100 between converging waveguides, using a second example technique for determining a location for the first end 502 of the support structure 100.

In this second example technique, a second location 802 is identified. The second location 802 indicates a location where the width of the third waveguide 402 is equal to the width 104 of the support structure 100. The first end 502 is then placed at this first location, at a position overlapping the third waveguide 402 such that the support structure 100 extends from the center of the tip of the third waveguide 402.

In this example, as in FIG. 7, the second end 504 of the support structure 100 is placed at a midpoint of the boundary 410 between the second region 416 and third region 418, equidistant from the first waveguide 216 and second waveguide 218.

The second example technique applied in FIG. 8 can serve to reduce or eliminate the unwanted optical behavior of the first example technique, due to the more central placement of the support structure 100 relative to the third waveguide 402.

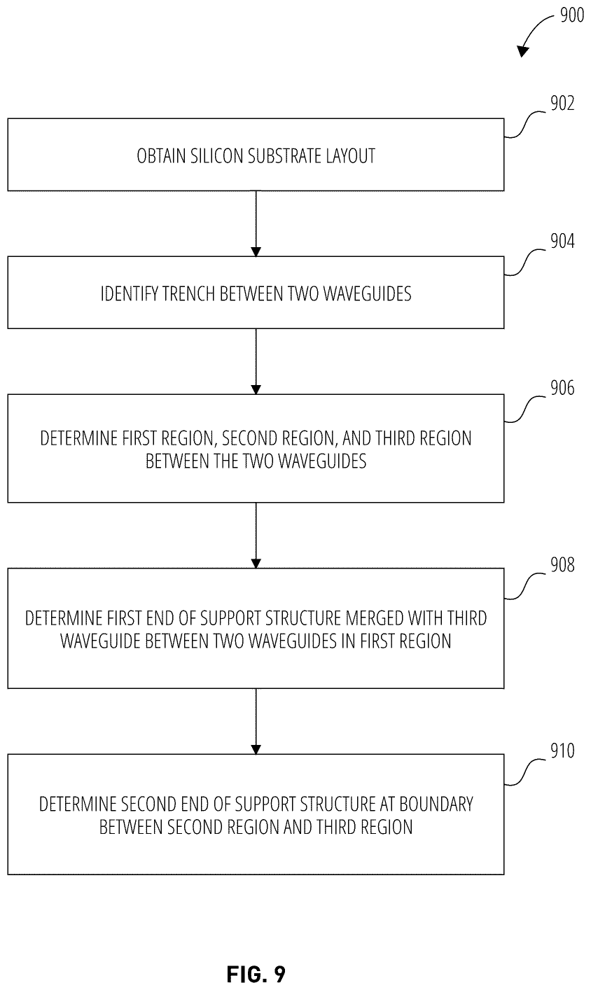

FIG. 9 shows operations of a method 900 for manufacturing a silicon photonic device. The method 900 is automatically performed by a computer, thereby simplifying the design of layouts for patterning silicon substrates for use in silicon photonic devices.

Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method 900 includes obtaining a silicon substrate layout at operation 902. The silicon substrate layout can be obtained from existing EDA software processes in some examples.

According to some examples, the method 900 includes identifying a trench between two waveguides at operation 904. EDA software implementing the techniques described herein can analyze the silicon substrate layout and mathematically or otherwise automatically identify trenches with large widths, and/or areas where two waveguides (e.g., first waveguide 216 and second waveguide 218) merge or converge such that their respective side trenches (e.g., second trench 404 and third trench 406) merge to form a single, wider trench (e.g., first trench 220).

According to some examples, the method 900 includes determining the first region 414, second region 416, and third region 418 between the two waveguides 216 and 218 at operation 906. The end of the third waveguide 402 defines the end of the first region 414; the point at which the width of the first trench 220 narrows to less than the width threshold determines the end of the second region 416. In some examples, the second region 416 is the region through which the support structure 100 is intended to extend.

According to some examples, the method 900 includes determining the first end 502 of the support structure 100 merged with the third waveguide 402 between the two waveguides 216 and 218 in the first region 414 at operation 908. The two alternative techniques described above with reference to FIG. 7 and FIG. 8 provide examples of how to implement operation 908.

According to some examples, the method 900 includes determining the second end 504 of the support structure 100 at the boundary 410 between the second region 416 and the third region 418 at operation 910. One such example technique is described above, in which the second end 504 is located on the boundary 410 equidistant from both waveguides 216 and 218.

Other examples of optical devices, systems, and methods may include features, and combinations or subcombinations of features, of the various examples described herein.

In view of the disclosure above, various examples are set forth below. It should be noted that one or more features of an example, taken in isolation or combination, should be considered within the disclosure of this application.

Example 1 is a silicon photonic device, comprising: a substrate formed from a silicon-containing material, the substrate being patterned to comprise: a first waveguide and a second waveguide defining a first trench therebetween, the first waveguide and second waveguide having upper surfaces exposed for bonding to an epitaxially grown layer, the first trench being exposed to the epitaxially grown layer; and a support structure formed within the first trench and extending upward to an upper surface at a height of the upper surfaces of the first waveguide and second waveguide, the support structure being optically non-functional.

In Example 2, the subject matter of Example 1 includes, wherein: the support structure comprises a rounded end.

In Example 3, the subject matter of Example 2 includes, wherein: the support structure further comprises a rectangular prism extending horizontally from the rounded end.

In Example 4, the subject matter of Examples 1-3 includes, wherein: a distance between the first waveguide and second waveguide decreases in a horizontal direction, thereby defining: a first region along the horizontal direction in which a third waveguide is located between the first waveguide and second waveguide, a second trench being defined between the third waveguide and the first waveguide, a third trench being defined between the third waveguide and the second waveguide, the second trench and third trench having respective widths in the first region of no more than a width threshold; a second region, bordering the first region in the horizontal direction, in which the first trench extends from the first waveguide to the second waveguide over a width greater than the width threshold; and a third region, bordering the second region in the horizontal direction, in which the first trench extends from the first waveguide to the second waveguide over a width no greater than the width threshold; and the support structure extends between: a first end that merges with the third waveguide in the first region; and a second end that extends to a boundary between the second region and the third region.

In Example 5, the subject matter of Example 4 includes, wherein: the width threshold is a value between 3 microns and 5 microns.

In Example 6, the subject matter of Examples 4-5 includes, wherein: the support structure has a width of between 0.3 microns and 0.7 microns.

In Example 7, the subject matter of Examples 4-6 includes, wherein: the third region ends in the horizontal direction at a merge location where the first waveguide merges with the second waveguide.

Example 8 is a computer-implemented method for manufacturing a silicon photonic device, comprising: obtaining a silicon substrate layout comprising a pattern for patterning a substrate formed from a silicon-containing material; processing the silicon substrate layout to automatically identify a first trench defined between a first waveguide and a second waveguide, the first waveguide and second waveguide having upper surfaces exposed for bonding to an epitaxially grown layer, the first trench being exposed to the epitaxially grown layer; and modifying the silicon substrate layout to generate a modified silicon substrate layout by automatically adding a support structure formed within the first trench and extending upward to an upper surface at a height of the upper surfaces of the first waveguide and second waveguide, the support structure being optically non-functional.

In Example 9, the subject matter of Example 8 includes, for each of one or more additional trenches of the silicon substrate layout, repeating the automatic identifying of the additional trench and the automatic adding of the support structure within the additional trench.

In Example 10, the subject matter of Example 9 includes, manufacturing the silicon photonic device based on the modified silicon substrate layout.

In Example 11, the subject matter of Examples 8-10 includes, wherein: the support structure comprises a rounded end.

In Example 12, the subject matter of Example 11 includes, wherein: the support structure further comprises a rectangular prism extending horizontally from the rounded end.

In Example 13, the subject matter of Examples 8-12 includes, wherein: a distance between the first waveguide and second waveguide decreases in a horizontal direction, thereby defining: a first region along the horizontal direction in which a third waveguide is located between the first waveguide and second waveguide, a second trench being defined between the third waveguide and the first waveguide, a third trench being defined between the third waveguide and the second waveguide, the second trench and third trench having respective widths in the first region of no more than a width threshold; a second region, bordering the first region in the horizontal direction, in which the first trench extends from the first waveguide to the second waveguide over a width greater than the width threshold; and a third region, bordering the second region in the horizontal direction, in which the first trench extends from the first waveguide to the second waveguide over a width no greater than the width threshold; and the support structure is added by: processing the silicon substrate layout to determine a first end for the support structure merged with the third waveguide in the first region; processing the silicon substrate layout to determine a second end for the support structure at a boundary between the second region and the third region; and adding the support structure to extend between the first end and the second end.

In Example 14, the subject matter of Example 13 includes, wherein: the width threshold is a value between 3 microns and 5 microns.

In Example 15, the subject matter of Examples 13-14 includes, wherein: the support structure has a width of between 0.3 microns and 0.7 microns.

In Example 16, the subject matter of Examples 13-15 includes, wherein: the third region ends in the horizontal direction at a merge location where the first waveguide merges with the second waveguide.

In Example 17, the subject matter of Examples 13-16 includes, wherein: the processing of the silicon substrate layout to determine the first end for the support structure comprises: identifying a first location at which the width of the second trench is greater than a width threshold; and locating the first end of the support structure at the first location.

In Example 18, the subject matter of Examples 13-17 includes, wherein: the processing of the silicon substrate layout to determine the first end for the support structure comprises: identifying a second location at which the width of the third waveguide is equal to a width of the support structure; and locating the first end of the support structure at the second location.

In Example 19, the subject matter of Examples 13-18 includes, wherein: the processing of the silicon substrate layout to determine a second end for the support structure comprises: locating the second end of the support structure at a point equidistant from the first waveguide and the second waveguide on the boundary between the second region and the third region.

Example 20 is a non-transitory computer-readable storage medium, the computer-readable storage medium including instructions that when executed by a processor of a system, cause the system to perform operations comprising: obtaining a silicon substrate layout comprising a pattern for patterning a substrate formed from a silicon-containing material; processing the silicon substrate layout to automatically identify a first trench defined between a first waveguide and a second waveguide, the first waveguide and second waveguide having upper surfaces exposed for bonding to an epitaxially grown layer, the first trench being exposed to the epitaxially grown layer; and modifying the silicon substrate layout to generate a modified silicon substrate layout by automatically adding a support structure formed within the first trench and extending upward to an upper surface at a height of the upper surfaces of the first waveguide and second waveguide, the support structure being optically non-functional.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A silicon photonic device, comprising:
a substrate formed from a silicon-containing material, the substrate being patterned to comprise:
a first waveguide and a second waveguide defining a first trench extending between the first waveguide and the second waveguide, the first waveguide and second waveguide having upper surfaces exposed for bonding to an epitaxially grown layer, the first trench being exposed to the epitaxially grown layer; and
a support structure formed within the first trench and extending upward to an upper surface at a height of the upper surfaces of the first waveguide and second waveguide, the support structure being optically non-functional.

2. The silicon photonic device of claim 1, wherein:
the support structure comprises a rounded end.

3. The silicon photonic device of claim 2, wherein:
the support structure further comprises a rectangular prism extending horizontally from the rounded end.

4. The silicon photonic device of claim 1, wherein:
a distance between the first waveguide and second waveguide decreases in a horizontal direction, thereby defining:
a first region along the horizontal direction in which a third waveguide is located between the first waveguide and second waveguide, a second trench being defined between the third waveguide and the first waveguide, a third trench being defined between the third waveguide and the second waveguide, the second trench and third trench having respective widths in the first region of no more than a width threshold;
a second region, bordering the first region in the horizontal direction, in which the first trench extends from the first waveguide to the second waveguide over a width greater than the width threshold; and
a third region, bordering the second region in the horizontal direction, in which the first trench extends from the first waveguide to the second waveguide over a width no greater than the width threshold; and
the support structure extends between:
a first end that merges with the third waveguide in the first region; and
a second end that extends to a boundary between the second region and the third region.

5. The silicon photonic device of claim 4, wherein:
the width threshold is a value between 3 microns and 5 microns.

6. The silicon photonic device of claim 4, wherein:
the support structure has a width of between 0.3 microns and 0.7 microns.

7. The silicon photonic device of claim 4, wherein:
the third region ends in the horizontal direction at a merge location where the first waveguide merges with the second waveguide.

8. A computer-implemented method for manufacturing a silicon photonic device, comprising:
obtaining a silicon substrate layout comprising a pattern for patterning a substrate formed from a silicon-containing material;
processing the silicon substrate layout to automatically identify a first trench defined between a first waveguide and a second waveguide, the first waveguide and second waveguide having upper surfaces exposed for bonding to an epitaxially grown layer, the first trench being exposed to the epitaxially grown layer; and
modifying the silicon substrate layout to generate a modified silicon substrate layout by automatically adding a support structure formed within the first trench and extending upward to an upper surface at a height of the upper surfaces of the first waveguide and second waveguide, the support structure being optically non-functional.

9. The method of claim 8, further comprising:
for each of one or more additional trenches of the silicon substrate layout, repeating the automatic identifying of the additional trench and the automatic adding of the support structure within the additional trench.

10. The method of claim 9, further comprising:
manufacturing the silicon photonic device based on the modified silicon substrate layout.

11. The method of claim 8, wherein:
the support structure comprises a rounded end.

12. The method of claim 11, wherein:
the support structure further comprises a rectangular prism extending horizontally from the rounded end.

13. The method of claim 8, wherein:
a distance between the first waveguide and second waveguide decreases in a horizontal direction, thereby defining:
a first region along the horizontal direction in which a third waveguide is located between the first waveguide and second waveguide, a second trench being defined between the third waveguide and the first waveguide, a third trench being defined between the third waveguide and the second waveguide, the second trench and third trench having respective widths in the first region of no more than a width threshold;
a second region, bordering the first region in the horizontal direction, in which the first trench extends from the first waveguide to the second waveguide over a width greater than the width threshold; and
a third region, bordering the second region in the horizontal direction, in which the first trench extends from the first waveguide to the second waveguide over a width no greater than the width threshold; and
the support structure is added by:
processing the silicon substrate layout to determine a first end for the support structure merged with the third waveguide in the first region;
processing the silicon substrate layout to determine a second end for the support structure at a boundary between the second region and the third region; and
adding the support structure to extend between the first end and the second end.

14. The method of claim 13, wherein:
the width threshold is a value between 3 microns and 5 microns.

15. The method of claim 13, wherein:
the support structure has a width of between 0.3 microns and 0.7 microns.

16. The method of claim 13, wherein:
the third region ends in the horizontal direction at a merge location where the first waveguide merges with the second waveguide.

17. The method of claim 13, wherein:
the processing of the silicon substrate layout to determine the first end for the support structure comprises:
identifying a first location at which the width of the second trench is greater than a width threshold; and
locating the first end of the support structure at the first location.

18. The method of claim 13, wherein:
the processing of the silicon substrate layout to determine the first end for the support structure comprises:
identifying a second location at which the width of the third waveguide is equal to a width of the support structure; and
locating the first end of the support structure at the second location.

19. The method of claim 13, wherein:
the processing of the silicon substrate layout to determine a second end for the support structure comprises:
locating the second end of the support structure at a point equidistant from the first waveguide and the second waveguide on the boundary between the second region and the third region.

20. A non-transitory computer-readable storage medium, the computer-readable storage medium including instructions that when executed by a processor of a system, cause the system to perform operations comprising:
obtaining a silicon substrate layout comprising a pattern for patterning a substrate formed from a silicon-containing material;
processing the silicon substrate layout to automatically identify a first trench defined between a first waveguide and a second waveguide, the first waveguide and second waveguide having upper surfaces exposed for bonding to an epitaxially grown layer, the first trench being exposed to the epitaxially grown layer; and
modifying the silicon substrate layout to generate a modified silicon substrate layout by automatically adding a support structure formed within the first trench and extending upward to an upper surface at a height of the upper surfaces of the first waveguide and second waveguide, the support structure being optically non-functional.
